(19) United States
(12) Patent Application Publication
(10) Pub. No.: US 2005/0270959 A1
(43) Pub. Date: Dec. 8, 2005

(54) Recording method for optical recording medium, and optical recording apparatus

(76) Inventors: Hiroyuki Iwasa, Yokohama-shi (JP); Michiaki Shinotsuka, Hiratsuka-shi (JP); Masaru Shinkai, Yokohama-shi (JP)

Correspondence Address: DICKSTEIN SHAPIRO MORIN & OSHINSKY LLP, 2101 L Street, NW, Washington, DC, 20037, US

(21) Appl. No.: 11/142,389

(22) Filed: Jun. 2, 2005

(30) Foreign Application Priority Data
Jun. 2, 2004 (JP) 2004-164685

(51) Int. Cl. G11B 5/09; G11B 7/00

(52) U.S. Cl. 369/116; 369/59.11; 369/47.5

(57) ABSTRACT

The present invention is a recording method for optical recording medium forms a few types of amorphous mark vary from at least any one from length and area upon repeated irradiation by a recording power (Pw) light and a cooling power (Pb) light to an information layer comprising a phase-changing recording layer of the optical recording medium, and records information and forms a crystal space upon irradiation of an erasing power (Pe) light, wherein the recording power (Pw) light, the cooling power (Pb) light, and the erasing power (Pe) light satisfying a relation of the following equation Pw>Pe>Pb, and in the case of forming at least one type of amorphous mark upon irradiation by a cooling controlling power (Pm) light to in between the recording power (Pw) light and cooling power (Pb) light, wherein the recording power (Pw) light, cooling power (Pb) light , and cooling controlling power (Pm) light satisfying a relation of the following equation Pw>Pm>Pb.

### BACKGROUND OF THE INVENTION

1. Field of the Invention

The present invention relates to a recording method for optical recording medium, and an optical recording apparatus suitable for alterable phase-changing optical recording medium, especially multi-layer phase-changing optical recording medium where the information layer is multi-layer formed, and capable of forming a 3 value or more multi-value recording mark in a recording cell by irradiating laser beam to the multi-layer phase-changing optical recording medium.

2. Description of the Related Art

Phase-changing optical disk (phase-changing optical recording medium) of CD-RW generally has a basic composition forming a recording layer made from a phase-changing material which is arranged on a plastic substrate and on top of this layer, a reflective layer that besides upgrading the light absorption rate of the recording layer, has thermal diffusion effect, and carries out recording reproduction of information by irradiating laser beam from the side of a substrate.

A phase-changing material changes phase between crystalline and amorphous state, after quick heating, quenches and becomes an amorphous and when slow cooled, crystallizes based on heating and after that cooling by laser beam irradiation, and a phase-changing optical recording medium is an application of the optical change of crystal and amorphous in recording reproduction of the information. The phase-changing optical recording medium changes disk reflectance, records information, and reproduces by changing recording material between crystal and amorphous by irradiating and heating a phase-changing recording layer on a substrate. Generally, an unrecorded state acts as a high reflectance crystal phase and in this phase, the recording of information is carried out by forming a mark from low reflectance amorphous and a space from high reflectance crystal section.

The object to prevent oxidation, perspiration or deformation of recording layer upon heating by light irradiation, generally a lower protective layer (also named as lower dielectric layer below) and an upper protective layer (also named as upper dielectric layer below) are arranged in between the substrate and recording layer, and the recording layer and reflective layer, respectively. Further, these protective layers comprise modulating function of optical properties of recording medium by controlling the thickness. The lower protective layer also has a function to prevent softening of the substrate by the heat to the recording layer during recording time.

As phase-changing optical recording medium uses complex mechanism such as ‘quenching’ and ‘slow cooling’, mark forming is performed by irradiating a recording use laser that is pulse-splitted and intensity modulated to 3 value to a medium. As the waveform emission pattern (recording strategy) for repeated recording of data from a mark and space, a pattern used in DVD+RW is shown in FIG. 1. The mark from amorphous is formed upon pulse irradiation by alternate repetition of recording power (Pw) light and cooling power (Pb) light, and the space from crystal is formed upon continuous irradiation of erasing power (Pe) light of the middle level of these. Direct over write (DOW) where old data is erased and simultaneously, new data is recorded on one beam spot.

When a pulse train from recording power light and cooling power light is irradiated, recording layer melts and quenches repeatedly and an amorphous mark is formed. When erasing power light is irradiated, recording layer melts, then cooled slowly or annealed in solid phase and crystallized and a space is formed. The pulse train from recording power light and cooling power light is usually divided into leading pulse, middle pulse, final pulse, the shortest 3T mark (T:basic clock cycle) is recorded only by leading pulse and last pulse, and when forming the 4T mark or more, middle pulse is also used. Middle pulse is also called multi-pulse, set up with 1T cycle and whenever mark length is 1T longer, pulse number is increased one by one. The number of pulse train is (n−1) against length nT.

In recent years, the amount of information managed by computers is increasing, large capacity advancement of hard disk is also progressing, and the information capacity in optical recording medium of CD and DVD is becoming insufficient. Although the information capacity of CD at present is 650 MB and DVD is 4.7 GB, in the future, further technical development of high recording density enhancement and large capacity enhancement is demanded.

For example, shortening the wavelength of laser wavelength being used to the blue light region, or enlarging the number of aperture (NA) if objective lens used in pickup that performs recording reproduction and decreasing the spot size of laser beam irradiated to optical recording medium as the method for high recording density enhancement of the phase-changing optical recording medium are proposed.

Also, separately from this, multi-value recording method as the technical for making high-density advancement and high speed advancement of recording medium possible is gaining attention, for example, a method for the recording of multi-value information by percentage of occupying as compared with circumference crystal section of amorphous recording mark and accomplishing the recording capacity of 20 GB or more in ‘International Symposium on Optical Memory2001 Technical Digest P300’ is proposed.

In FIG. 2, the relation between mark occupying rate and Rf signal is shown. The recording mark 33 is imagined to be arranged on the center of each divided cell by track direction. The recording mark 33 has the same relation with alterable phase-changing material or phase pit being recorded as irregular shape of substrate. For the case where recording mark 33 is phase pit being recorded as irregular shape of substrate, it is necessary that the optical channel depth of phase pit is λ/4 (λ is the wavelength of recording reproduction laser) so that the signal gain of Rf signal becomes maximum. Rf signal value is given by the value where the condensing beam for recording reproduction is arranged on the center of cell and changes with various percentage of occupying of the recording mark 33 occupying in a cell. Generally, when the recording mark 33 does not exist, Rf signal value is maximum and when the percentage of occupying of recording mark 33 is the highest, it is minimum. Further, in FIG. 2, recording track width 30, cell length 31 (the same as cell length 104 in FIG. 4), beam spot 32, and crystalline section 34 are shown.

According to the area modulating system, for example, when multi-value recording is performed with recording mark pattern number (multi-value level number)=6, Rf signal value from each recording mark pattern is shown by distribution in FIG. 3. Rf signal value is shown by normalized numeric when the amplitude of the maximum value and minimum value (dynamic range DR) is 1. Recording reproduction is performed using optical system of λ=650 nm and number of aperture NA=0.65 (condensing beam diameter=about 0.8 μm), and the circumferential direction length of cell 100 (shown as cell length 104 below) is about 0.6 μm. This multi-value recording mark 101 can be formed by laser modulation as shown by recording strategy in FIG. 4, where the power of Pw, Pe, Pb and their starting time 105 are parameters.

For the above-mentioned multi-value recording system, when recording linear density is increased (=shortening the cell length in track direction), by order, cell length shortens as compared with condensing beam diameter and when reproducing the object cell, condensing beam comes out in the cell in front of and behind the object cell. Due to this, even if the mark occupying percentage of the object cell is the same, Rf signal value reproduced from the object cell receives the effect by the combination of the mark occupying percentage of the cell in front and behind. Specifically, signal interference between the mark in front and behind occurs. Due to this effect, Rf signal value for each pattern becomes a distribution having deviation as shown in FIG. 3. To judge which pattern of the recording mark is the object cell without mistakes, it is necessary that the interval of Rf signal value reproduced from each recording mark is above-mentioned deviation or more apart. For FIG. 3, the interval of Rf signal value of each recording mark and deviation is the same and it is the limit capable of the judgment of recording mark pattern.

As a technique defeating this limit, multi-value judging technique DDPR using continuous 3 data cells is proposed ‘International Symposium on Optical Memory2001 Technical Digest P300’. This technique studies multi-signal distribution from the combination pattern of continuous 3 data cells (when it is 8 value recording, 8³=512) and it is from the step multi-value judging the reproducing object of unknown signal referring to the above-mentioned pattern table after estimating the step making this pattern table and the 3 continuous mark pattern from the reproducing signal results of unknown data. According to this, it is possible to lower the error of multi-signal judging even for the past cell density where signal interference occurs during reproduction or SDR value. Here, SDR value is the ratio of the average value of standard deviation σᵢ of each multi-value signal when multi-value tone number is n and the dynamic range DR of multi-value Rf signal, namely, shown by Σσᵢ/(n×DR) and a signal quality corresponds to the jitter for 2 value recording. Generally, when multi-value tone number n is constant, SDR value becomes smaller with smaller standard deviation σᵢ of multi-value signal and larger dynamic range DR, and the differential properties of multi-value signal becomes better and error rate becomes smaller. On the contrary, when multi-value tone number n becomes larger, SDR value becomes larger and error rate becomes larger.

When using this multi-value judging technique, for example, even for the case in FIG. 5 where multi-value tone number is increased to 8 and the distribution of each Rf signal value overlaps, multi-value judgment of 8 value becomes possible with error rate 10⁻⁵.

As the method for improving optical recording medium itself and raising the recording capacity, two-layered phase-changing optical recording medium of the structure of two overlapped information layer at least from recording layer and reflective layer on one side of substrate, and these information layers are glued together by ultraviolet cured resin, for example, is proposed in Japanese Patent (JP-B) No. 2702905, Japanese Patent Application Laid-Open (JP-A) Nos. 2000-215516, 2000-222777, and 2001-243655.

The separating layer which is the adhesive section of the in-between of the information layers (also named as intermediate layer below), comprises a function optically separating two information layers and as it is necessary that the laser beam for information reproduction use is plenty and reaches the inner part of the information layer as possible, it is composed of materials that do not absorb laser beam as possible.

This two-layered phase-changing optical recording medium, for example, also in ‘ODS2001 Technical Digest P22’, though announced in scientific society, a lot of problem still exists.

For example, if the laser beam does not transmit the information layer (first information layer) at the front side of the laser beam irradiating side sufficiently, information can not be recorded and reproduced in the recording layer of the information layer (second information layer) back side, as a result, it is thought that the reflective layer comprising first information layer is eliminated or made extremely thin, or recording layer comprising first information layer is made extremely thin.

Recording according to the phase-changing optical recording medium is performed by irradiating laser beam to phase-changing material of the recording layer, quenching, changing crystal to amorphous and forming a mark so that reflective layer is eliminated or when it is made very thin to 10 nm, thermal diffusion effect becomes smaller and it becomes difficult to form amorphous mark.

For the recording strategy of first information layer, examples of proposal are as followings.

In Japanese Patent Application Laid-Open (JP-A) No. 2001-273638, for 4T or more mark, in front of the leading pulse of pulse train forming the mark also, the time maintaining to low power level of cooling power level is provided. Specifically, when the time irradiating with high power of the leading pulse and time maintaining to low power level are yT and xT, respectively, the following equation, a relation of 0.95<xT+0.7×yT<2.5 is satisfied, and further, the cycle of continuous pulse is fixed to 0.5T to 1.5T.

In Japanese Patent Application Laid-Open (JP-A) No. 2003-257025, at least one of the leading pulse and last pulse is fixed to a level lower than multi-pulse.

In Japanese Patent Application Laid-Open (JP-A) No. 2003-178448, by controlling the power retention time and power level of Pw and Pb of pulse train forming the mark, the cooling time of recording layer of the first information layer is steep and a amorphous mark strongly formed is proposed.

However, the above-mentioned JP-A No. 2001-273638 is a recording method for forming comparatively long mark of 4T mark or more, the problem relating to the forming of micro mark like multi-value recording is not suggested at all. In the above-mentioned JP-A No. 2003-257025, it is effective for forming comparatively long mark where pulse train of Pw and Pe is fixed at 2 or more, however, when forming micro mark like multi-value recording, usually, as the pulse train is only one as shown in FIG. 4, this technique is not suitable for multi-value recording.

The method of forming a mark based on making the cooling time of recording layer steep by shortening pulse duration of Pw level, lengthening pulse duration of Pb level as shown in JP-A No. 2003-178448 was effective in 2 value recording, when cell length is 0.25 μm and 8 value recording was performed as shown by strategy on FIG. 4, with only the adjustment of the level and retention time of Pw and Pe, it was difficult to modulate the mark shape to 8 value. Above all, it is understood that when the hold time of Pe is lengthened, recrystallization is controlled and it becomes easier to form amorphous mark, however, when the retention time is too long, on the contrary, large amorphous mark is formed and comes out form the cell, and signal interference becomes larger.

The inventors of the present invention performed multi-value recording of basic cell=0.24 μm, linear speed 6.0 m/s, multi-value level number=8, using optical disk evaluation apparatus DDU-1000 of laser wavelength 405 nm and NA=0.65 (manufactured by Pulstec Industiral Co., Ltd.) in first information layer of two-layered phase-changing optical recording medium. Recording strategy is fixed like FIG. 8 as compared with multi-value data Mi (however, i=0, 1, . . . , 7). This is the usual recording strategy and is arranged so as to have reflectance modulation by changing pulse duration of Pb according to multi-value data.

FIG. 9 shows the reproduction signal shape when recording with Pw=14 mW, Pe=6 mW, Pb=0.1 mW, using this recording strategy. The recorded data pattern is a repetition of 4 continuous level 0 and one other than level 0. For the case of using recording strategy as shown in FIG. 8 as compared to previous one layer phase-changing optical recording medium, according to multi-value level 0, 1, 2, 3 . . . , reflected light intensity becomes lower one by one and multi-value modulation was performed satisfactorily like FIG. 3, however, for the case of using the usual recording strategy in multi-layer optical recording medium, multistage modulation was not successful as shown in FIG. 9. Besides recording strategy in FIG. 8, Pw level and Pw pulse duration were changed but the result was the same.

Accordingly, for phase-changing optical recording medium, especially multi-layered phase-changing optical recording medium, recording method of optical recording medium able to form strongly micro amorphous mark and also perform satisfactorily multi-value recording of 3 value or more is not obtained and its rapid supply is desired at present situation.

### SUMMARY OF THE INVENTION

The object of the present invention is to provide a recording method for optical recording medium and optical recording apparatus able to form strongly micro amorphous mark and also perform satisfactorily multi-value recording of 3 value or more for phase-changing optical recording medium, especially multi-layered phase-changing optical recording medium.

The recording method for optical recording medium of the present invention, forms a few types of amorphous mark vary from at least any one from length and area upon repeated irradiation by a recording power (Pw) light and a cooling power (Pb) light to an information layer comprising a phase-changing recording layer of the optical recording medium, and

records information and forms crystal space upon irradiation of an erasing power (Pe) light,

the recording power (Pw) light, the cooling power (Pb) light, and the erasing power (Pe) light satisfying a relation of the following equation Pw>Pe>Pb, and

in the case of forming at least one type of amorphous mark upon irradiation by a cooling controlling power (Pm) light to in between the recording power (Pw) light and cooling power (Pb) light,

the recording power (Pw) light, cooling power (Pb) light, and cooling controlling power (Pm) light satisfying a relation of the following equation Pw>Pm>Pb.

According to the recording method for optical recording medium of the present invention, phase-changing optical recording medium, especially multi-layered phase-changing optical recording medium is able to form strongly micro amorphous mark and also perform satisfactorily multi-value recording of 3 value or more.

The optical recording apparatus of the present invention, by irradiating a laser beam from a light source to an optical recording medium, performs recording of information in an information layer comprising a phase-changing recording layer of the concerned optical recording medium and carries out a recording method of the optical recording medium of the present invention.

According to the optical recording apparatus of the present invention, phase-changing optical recording medium, especially multi-layered phase-changing optical recording medium is able to form strongly micro amorphous mark and also perform satisfactorily multi-value recording of 3 value or more.

### BRIEF DESCRIPTION OF THE DRAWINGS

FIG. 1 shows recording strategy used in DVD+RW, and the like.

FIG. 2 shows the relation between mark occupying rate and Rf signal.

FIG. 3 shows distribution of Rf signal value from each recording mark pattern for the case where multi-value recording is performed with recording mark pattern number (multi-value level number)=6, according to the area modulating system.

FIG. 4 shows recording strategy for forming multi-value recording mark.

FIG. 5 shows overlapping example of distribution of each Rf signal value with multi-value tone number 8.

FIG. 6 is a cross-sectional view showing an example of phase-changing optical recording medium comprising two layers of information layer.

FIG. 7 is a cross-sectional view showing another example of phase-changing optical recording medium comprising two layers of information layer.

FIG. 8 shows the usual recording strategy arranged so as to have reflectance modulation by changing pulse duration of Pb according to multi-data.

FIG. 9 shows reproduction signal shape when recording using recording strategy of FIG. 8.

FIG. 10 shows an example of pulse pattern using recording method of the present invention.

FIG. 11 shows another example of pulse pattern using recording method of the present invention.

FIG. 12 shows further another example of pulse pattern using recording method of the present invention.

FIG. 13 shows further another example of pulse pattern using recording method of the present invention.

FIG. 14 shows an example of optical recording apparatus for performing 2 value recording using EFM modulation system of the present invention.

FIG. 15 shows recording strategy using the examples.

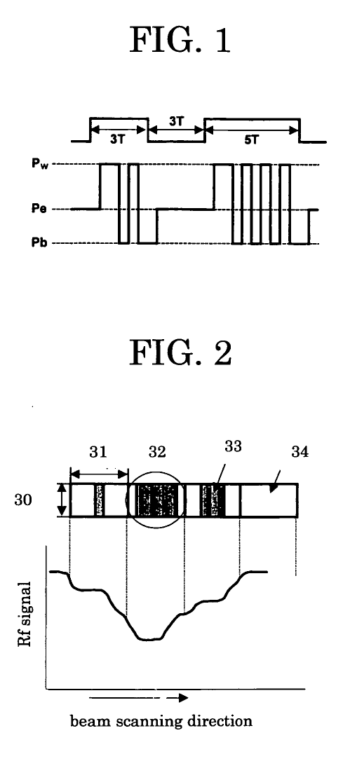

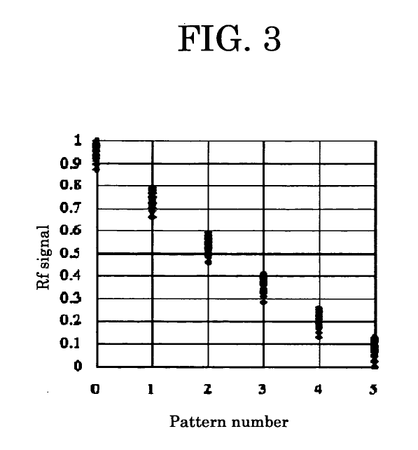

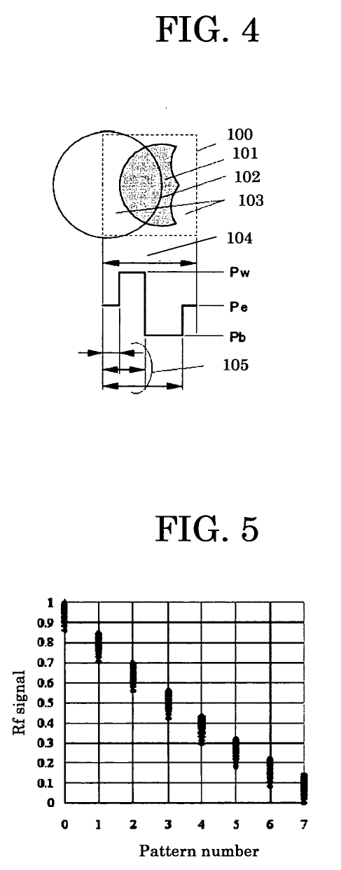

### DESCRIPTION OF THE PREFERRED EMBODIMENTS

(Recording Method for Optical Recording Medium)

The recording method for optical recording medium of the present invention, forms a few types of amorphous mark vary from at least any one from length and area upon repeated irradiation by a recording power (Pw) light and a cooling power (Pb) light to an information layer comprising a phase-changing recording layer of the optical recording medium, and

records information and forms crystal space upon irradiation of an erasing power (Pe) light,

the recording power (Pw) light, the cooling power (Pb) light, and the erasing power (Pe) light satisfying a relation of the following equation Pw>Pe>Pb, and

in the case of forming at least one type of amorphous mark upon irradiation by a cooling controlling power (Pm) light to in between the recording power (Pw) light and cooling power (Pb) light,

the recording power (Pw) light, cooling power (Pb) light, and cooling controlling power (Pm) light satisfying a relation of the following equation Pw>Pm>Pb.

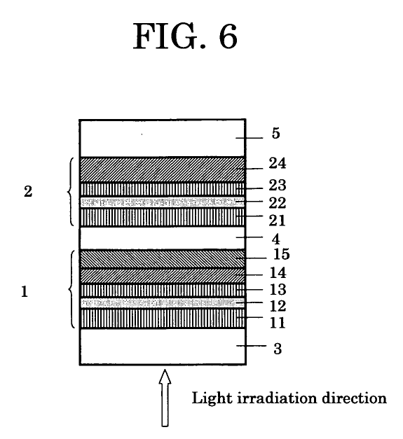

Here, phase-changing optical recording medium comprising two layers of information layer as shown in FIG. 6, namely, recording method and especially the recording strategy for the case of performing data recording in the above-mentioned first information layer of phase-changing optical recording medium comprising a structure laminated by first information layer 1, intermediate layer 4, second information layer 2 and second substrate 5 on first substrate 3 one by one is described. Further, it does not matter if recording strategy known before is used for second information layer.

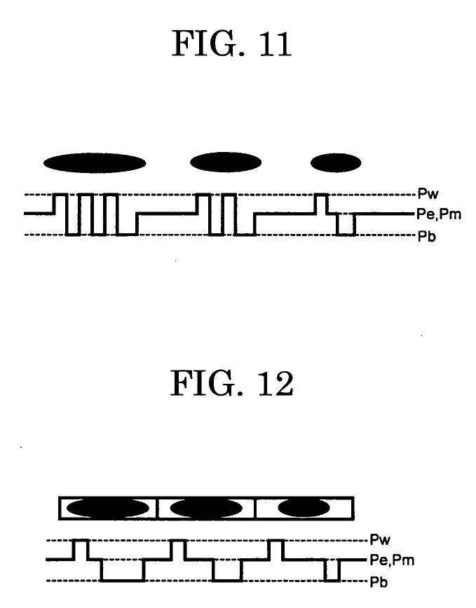

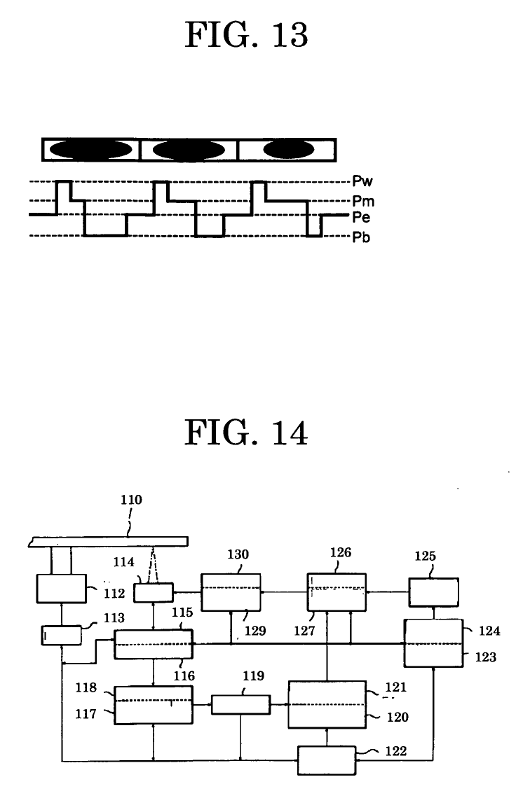

Examples of pulse pattern applied in recording method for optical recording medium of the present invention are shown in FIGS. 10 to 13. FIGS. 10 and 11 show pulse pattern examples that can be preferably applied in high density 2 value recording use, FIGS. 12 and 13 show pulse pattern examples that can be preferably applied in multi-value recording use.

For the present invention, micro recording mark is formed by light of recording power (Pw), erasing power (Pe) and cooling power (Pb) (however, Pw>Pe>Pb), and cooling controlling power (Pm) comprising Pw>Pm>Pb level. The cooling controlling power (Pm) is provided in between recording power (Pw) pulse and cooling power (Pb) pulse. In the case of plural repeating of recording power pulse and cooling power pulse, it is preferable that the cooling controlling power pulse is provided in at least one place between recording power pulse and cooling power pulse. However, it is preferable that the number of recording power pulse and cooling power pulse is less than a mark for the simplification of recording strategy.

Each power level of the above-mentioned recording power (Pw) light, cooling power (Pb) light, and erasing power (Pe) light can be suitably decided according to the structure of optical recording medium or optical system of optical recording apparatus. For example, Pw is preferable to be a value where the recording layer melts when reaching melting point or more, and Pb is preferable to be a value where the heated recording layer by Pw is quenched and amorphous mark is formed. Pe is preferable to be a value where in the case of over write, the recording layer reaches crystallization temperature or more and amorphous mark is crystallized.

The cooling controlling power level (Pm) is preferable to be lower level than Pw and besides higher level than Pb, and for the simplification of recording strategy, more preferable that erasing power (Pe) and cooling controlling power (Pm) are equal (Pe=Pm).

In the case of controlling the length of amorphous mark in 2 value recording, and in the case of controlling the area of amorphous mark in multi-value recording, the irradiation time (pulse duration) of cooling controlling power is changed and the adjustment of the size of mark is performed. It is preferable to lengthen the irradiation time of cooling controlling power the longer the long mark or the bigger area the mark, and to shorten the irradiation time of cooling controlling power the longer the short mark or the smaller area the mark. At this time, it does not matter whether the power level and pulse duration of Pw and Pb between mark are changed.

The recording method for optical recording medium of the present invention is effective even in the usual 2 value recording, however, it is especially effective in the case of high density 2 value recording or multi-value recording where the size of amorphous mark becomes smaller than the beam diameter of recording light. However, in the case where the pulse pattern of the present invention is applied in 2 value recording, it is preferable that it is applied in mark smaller than the beam diameter of recording light (especially the smallest mark) and it is not always necessary to apply in the case of forming amorphous mark comprising sufficient size than the beam diameter of recording light.

Next, phase changing optical recording medium applied in the recording method of the present invention is usually laminated on the substrate in the order or reverse order of lower protective layer, phase changing recording layer, upper protective layer, and reflective layer. For large capacity enhancement, there are cases of comprising phase changing recording layer, two layers or more.

FIG. 6 is a cross-sectional view showing an example of phase-changing optical recording medium comprising two layers of phase-changing recording layer, and it is a structure laminated on first substrate 3 in the order of first information layer 1, intermediate layer 4, second information layer 2, and second substrate 5.

The first information layer 1 is preferable to comprise of first lower protective layer 11, first phase changing recording layer 12, first upper protective layer 13, first reflective layer 14, and first thermal diffusion layer 15.

The second information layer 2 is preferable to comprise of second lower protective layer 21, second phase changing recording layer 22, second upper protective layer 23, and second reflective layer 24.

It does not matter whether barrier layer (not shown in figure) is provided between the first upper protective layer 13 and first reflective layer 14 and/or second upper protective layer 23 and second reflective layer 24.

Further, the first information layer and second information layer of optical recording medium applied in the present invention are not limited to the above layer structure.

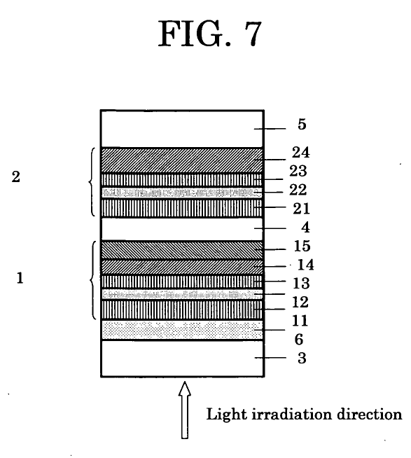

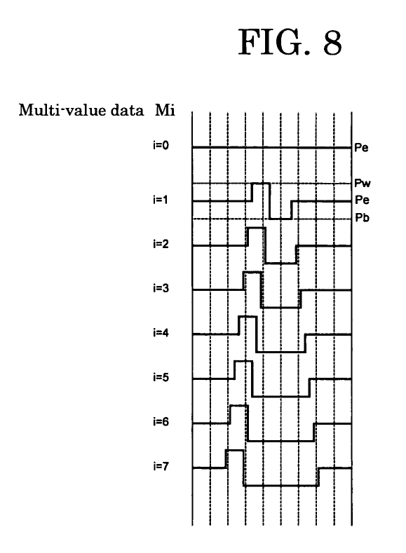

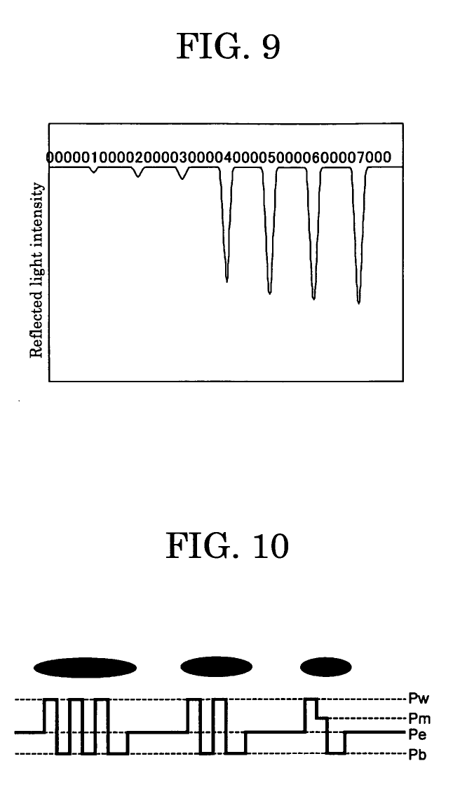

FIG. 7 is a cross-sectional view showing another example of phase-changing optical recording medium comprising two layers of recording layer, where transparent layer 6 is provided in between the first substrate 3 and first lower protective layer 11. A transparent layer like this uses sheeted material of thin thickness on the first substrate and is provided in the case where the manufacturing method is different from the optical recording medium of FIG. 6.

The first substrate is necessary to be a material where recording reproduction light is able to transmit sufficiently, however, material known in the past may be used in the technical field concerned, As for the material of the first substrate, usually, glass, ceramics or resin is used, however, from the point of formability and cost, resin is especially suitable.

Examples of the first substrate include a polycarbonate resin, an acrylic resin, an epoxy resin, a polystyrene resin, an acrylonitrile-styrene copolymer, a polyethylene resin, a polypropylene resin, a silicone resin, a fluorocarbon resin, an ABS resin, and a urethane resin. Of these, polycarbonate resin and acrylic resin of polymethyl methacrylate (PMMA) are particularly preferable, because they excel in formability, optical properties and cost.

On the surface of forming the information layer of the first substrate, according to necessity, normal groove part and land part that are spiral or concentric channel of tracking use of laser beam called irregular pattern can be formed, and this is usually formed by injection molding method or photopolymer method.

The thickness of the first substrate is preferably 10 μm to 600 μm and more preferable in the range of 70 μm to 120 μm or 550 μm to 600 μm.

As for a material of the second substrate, the same material as the first substrate can be used, however, an opaque material as compared with the recording reproduction light can be used, and as compared with the first substrate, the quality and channel shape that are different can be used.

The thickness of the second substrate has no limitation and can be suitably selected according to the purpose, and it is preferably to select a thickness so that the total thickness of this substrate and the first substrate becomes 1.2 mm.

Irregular pattern of groove or guide channel formed by injection molding method or photopolymer method can be formed on the second substrate, the same as the first substrate.

The intermediate layer and transparent layer is preferable that light absorption of the wavelength of the recording reproduction light is small, as for the material, resin is suitable because of formability and cost, and ultraviolet ray cured resin, delayed action resin or thermoplastic resin can be used. Double faced adhesive tape for optical disk sticking (for example, adhesive sheet DA-8320 manufactured by Nitto Denko Corporation) can be used.

Irregular pattern of groove or guide channel formed by injection molding method or photopolymer method can be formed on the intermediate layer, the same as the first substrate.

The intermediate layer, when performing recording reproduction, the pick up is capable of identifying and optically separating the first information layer and second information layer, and its thickness is preferably 10 μm to 70 μm. If the thickness is thinner than 10 μm, close talk between layers occurs, and if it exceeds 70 μm, during recording reproduction of second phase changing recording layer, spherical aberration occurs and recording reproduction becomes difficult.

The thickness of the transparent layer is not limited, however, it is necessary to adjust the thickness of the first substrate and transparent layer so that the thickness of the most suitable first substrate of optical recording medium manufactured by the manufacturing process where transparent layer like FIG. 6 is not provided, and the total thickness of the first substrate and transparent layer of optical recording medium with different manufacturing process like FIG. 7 become equal. For example, in the case of NA=0.85, if the thickness of the first substrate of optical recording medium in FIG. 6 is 75 μm, and excellent recording and erasing functions of are obtained, it is preferable that the thickness of transparent layer is 25 μm when the thickness of the first substrate of optical recording medium in FIG. 7 is 50 μm.

The first phase changing recording layer and second phase changing recording layer are preferable to use a material comprising at least Sb, and at least oine element selected from Ge, Ga, In, Zn, Mn, Sn, Ag, Mg, Ca, Bi, Se and Te.

Sb is made a base, and it is possible to form recording layer suitable for performing repeated recording of amorphous and crystal when having eutectic point about 600° C. or less in a binary system with Sb or combining element that forms solid solution. Base on the type and quantity of the combined element, the properties of the rate of crystallization, recording property, retention stability and accessibility of initialization are adjusted. Another element may be further added to the alloy of the above-mentioned element and Sb.

These recording layers can be formed by all kinds of gas phase epitaxy, for example, vacuum vapor deposition, sputtering method, plasma CVD method, optical CVD method, ion plating method, and electron beam deposition, and among these, sputtering method is excellent from the point of mass production property and film quality.

The thickness of the first phase changing recording layer has no particular limitation and can be suitably selected according to the purpose, and is preferably 3 nm to 10 nm and more preferably 3 nm to 8 nm. If the above-mentioned thickness is less than 3 nm, it becomes difficult to make uniform film, and if it exceeds 10 nm, transmittance declines.

The thickness of the second phase changing recording layer has no particular limitation and can be suitably selected according to the purpose, and is preferably 3 nm to 20 nm and more preferably 3 nm to 15 nm. If the above-mentioned thickness is less than 3 nm, it becomes difficult to make uniform layer, and if it exceeds 20 nm, recording sensitivity declines.

The first reflective layer and second reflective layer use incident light effectively and have functions such as increasing cooling rate and making easier amorphous making process, therefore, high thermal-conductivity metal is usually used, for example, Au, Ag, Cu, W, Al, Ta, or their alloy, can be used. Further, material that has at least one element of these elements as major component and added with at least one element selected from Cr, Ti, Si, Pd, Ta, Nd, or Zn, may be used.

Here, major component means occupying 90 atomic % or more atoms of the total material of the reflective layer and preferably 95 atomic % or more atoms.

Of these, Ag material has small refractive index (n) even in blue light wavelength region and light absorption can be restricted smaller at n is 0.5 or less, so it is preferable as a material used especially in the reflective layer of the first information layer of the two-layered optical recording medium like the present invention.

This reflective layer can be formed by all kinds of gas phase epitaxy, for example, vacuum vapor deposition, sputtering method, plasma CVD method, optical CVD method, ion plating method, and electron beam deposition, and of these, sputtering method is excellent from the point of mass production property and layer quality.

The first information layer is necessary to have high transmittance, therefore, as a material of the first reflective layer, it is preferable to use small refractive index and high thermal-conductivity Ag or its alloy.

The thickness of the first reflective layer is preferably 3 nm to 20 nm and more preferably 5 nm to 10 nm. If the above-mentioned thickness is less than 3 nm, it becomes difficult to make layer where the thickness is uniform and dense, and if it is thicker than 20 nm, transmittance declines and the recording reproduction of the second information layer becomes difficult.

The thickness of the second reflective layer forming the second information layer is preferably 50 nm to 200 nm and more preferably 80 nm to 150 nm. If the above-mentioned thickness is less than 50 nm, repeated recording property deteriorates and if it exceeds 200 nm, deterioration of sensitivity occurs.

The function and material of the first lower protective layer and second lower protective layer, and the second upper protective layer and second upper protective layer are the same as the case of single-layer phase-changing optical recording medium, to prevent change of properties of deterioration of first phase-changing recording layer and second phase-changing recording layer, enhance adhesive strength, and the usually known material having functions such as enhancing recording property is possible to be applied. The specific examples of these materials are oxides such as SiO, SiO₂, ZnO, SnO₂, Al₂O₃, TiO₂, In₂O₃, MgO, ZrO₂; nitrides such as Si₃N₄, AlN, TiN, ZrN; sulfides such as ZnS, In₂S₃, TaS₄; carbides such as SiC, TaC, B₄C, WC, TiC, ZrC; DLC (diamond-like carbon); or mixtures of these.

These materials may be made protective layer singularly, however, it can also be a mixture of one another. It may also contain impurity according to needs. It is necessary that the melting point of protective layer is higher than the one of information layer. It is most preferably a mixture of ZnS and SiO₂.

These protective layers can be formed by all kinds of gas phase epitaxy, for example, vacuum vapor deposition, sputtering method, plasma CVD method, optical CVD method, ion plating method, and electron beam deposition. Of these, sputtering method is excellent from the point of mass production property and layer quality.

The thickness of the first lower protective layer and second lower protective layer is preferably 30 nm to 200 nm. If the thickness is less than 30 nm, due to the heat during recording, the first substrate or intermediate layer deforms, and if it exceeds 200 nm, problems occur in mass production property. Accordingly, in the above region, the design of thickness is performed so that the most suitable reflectance is obtained.

The thickness of the first upper protective layer and second upper protective layer is preferably 3 nm to 40 nm and more preferably 6 nm to 20 nm. If the above-mentioned thickness is less than 3 nm, recording sensitivity declines, and if it exceeds 40 nm, heat-releasing effect cannot be obtained.

It does not matter to provide a barrier layer in between the upper protective layer and the reflective layer. As the above-mentioned, the reflective layer is most preferably Ag alloy, and the protective layer is most preferably a mixture of ZnS and SiO₂, however, if these 2 layers abut, it is possible that the sulfur in the protective layer corrodes the Ag of the reflective layer and there is a fear that the retention reliability declines. In order to eliminate this inconvenience, it is preferable to provide a barrier layer if an Ag material is used in the reflective layer.

The barrier layer does not contain sulfur and it is necessary that the melting point is higher than the one of the information layer, and it is preferable that the absorption rate is small at laser wavelength.

The material of the barrier layer has no limitation and can be suitably selected according to the purpose, for example, oxides such as SiO, ZnO, SnO₂, Al₂O₃, TiO₂, In₂O₃, MgO, ZrO₂; nitrides such as Si₃N₄, AlN, TiN, ZrN; carbides such as SiC, TaC, B₄C, WC, TiC, ZrC; or mixtures of these. Of these, SiC is especially preferable.

The barrier layer can be formed by all kinds of gas phase epitaxy, for example, vacuum vapor deposition, sputtering method, plasma CVD method, optical CVD method, ion plating method, and electron beam deposition. Of these, sputtering method is excellent from the point of mass production property and film quality.

The thickness of the barrier layer has no limitation and can be suitably selected according to the purpose, is preferably 2 nm to 10 nm and more preferably 2 nm to 5 nm. If the above-mentioned thickness is less than 2 nm, the effect preventing the corrosion of Ag is not obtained and the retention reliability declines, and if it exceeds 10 nm, heat-releasing effect is not obtained and transmittance declines.

It is desired that for the first thermal diffusion layer, thermal conductivity is high in order to quench recording layer irradiated by laser. It is preferable that the absorption rate is small at recording reproduction use laser wavelength so that recording reproduction of the back information layer is possible. For~the laser beam wavelength for recording reproduction use of information, the extinction coefficient is preferably 0.5 or less and more preferably 0.3 or less. If the extinction coefficient is bigger than 0.5, the absorption rate at the first information layer increases and the recording reproduction of the second information layer becomes difficult.

For the laser beam wavelength used for recording reproduction of information, the refractive index is preferably 1.6 or more. If the refractive index is less than 1.6, it becomes difficult to increase the transmittance of the first information layer.

From the above, the first thermal diffusion layer is preferable to contain at least one element from a nitride, an oxide, a sulfide, nitrogen oxide, a carbide, a fluoride. For example, AlN, Al₂O₃, SiC, SiN, TiO₂, SnO₂, In₂O₃, ZnO, ITO (indium oxide-stannum oxide), IZO (indium oxide-zinc oxide), ATO (stannum oxide-antimony oxide), DLC (diamond-like carbon), and BN. Of these, material having In₂O₃ as the main component is preferable, and more preferably ITO or IZO.

The first thermal diffusion layer can be formed by all kinds of gas phase epitaxy, for example, vacuum vapor deposition, sputtering method, plasma CVD method, optical CVD method, ion plating method, and electron beam deposition. Of these, sputtering method is excellent from the point of mass production property and film quality.

The thickness of the first thermal diffusion layer is preferably 10 nm to 200 nm and more preferably 20 nm to 100 nm. If the above-mentioned thickness is less than 10 nm, heat-releasing effect is not obtained, and if it exceeds 200 nm, stress becomes bigger, and not only the repeated recording property declines, problem also occurs in mass production property.

Further, the thermal diffusion layer is provided in between the first lower protective layer and first substrate and there is no problem at all attempting further enhancement of thermal diffusion.

The light transmittance of the first information layer is preferably 40% to 70% and more preferable 40% to 60% at recording reproduction use laser beam wavelength 350 nm to 700 nm.

For two-layered phase-changing optical recording medium that performs recording after initialization, the area of amorphous state of the recording layer is smaller than the area of crystal state of the recording layer, therefore, it does not matter if the light transmittance in amorphous state is smaller than the light transmittance in crystal state.

The optical recording apparatus of the present invention performs recording of information on an optical recording medium by irradiating laser beam from light source to the recording layer comprising phase-changing recording layer of the optical recording medium 110 and carries out recording method for the optical recording medium of the present invention.

Here, a configuration example of the optical recording apparatus to materialize a recording method according to the above-mentioned recording strategy is described in FIG. 14. FIG. 14 shows an example of optical recording apparatus for performing 2 value recording using EFM modulation system.

First of all, control roll 113 containing spindle motor 112 for rotary driving of optical recording medium 110 is provided to this optical recording medium 110, and light head 114 provided with light source of objective lens or diode laser that converges laser beam is prepared seek movement freely to this optical recording medium 110 in disk radius direction. Servomechanism 115 is connected to the objective lens drive unit or output system of light head 114. Reproduction signal detecting unit 116 related to reproduction motion calculating modulation factor from reproduction signal detected by acceptance element inside light head 114 is provided. Verbal detecting unit 118 containing programmable BPF 117 is connected to the servomechanism 115 and reproduction signal detecting unit 116. Address detection circuit 119 demodulating address from the detected verbal signal is connected to the verbal detecting unit 118. Recording clock generating unit 121 containing PLL synthesizer circuit 220 is connected to this address detection circuit 119. Drive controller 122 is connected to PLL synthesizer circuit 120.

Control roll 113, servomechanism 115, reproduction signal detecting unit 116, verbal detecting unit 118 and address detection circuit 119 are also connected to drive controller 122 that is connected to system controller 123. System controller 123 is provided with recording power operation unit 124 and EFM encoder 125 and LD control unit 126 are connected to it. This LD control unit 126 contains recording pulse train generating unit 127 that generates pulse train controlling signal normalized by recording strategy. By switching the drive current source 129 of each recording power (Pw), erasing power ('Pe), cooling power (Pb) and cooling controlling power (Pm), LD drive unit 130, a driver circuit of a light source drive unit for driving the diode laser inside light head 114 is connected to output of LD control unit 126.

In this configuration, in order to record in optical recording medium 110, the rotational frequency of spindle motor 112 upon controlling by drive controller 122 and after being controlled by control roll 113 so that the recording linear speed corresponds to the recording rate of the target, address detecting from verbal signal separate detected by programmable BPF 117 from push-pull signal obtained by light head 114 and, according to PLL synthesizer circuit 120, recording channel clock is generated and input to recording pulse train generating unit 127.

Next, in order to generate recording pulse of diode laser use, recording channel clock and recording information, EFM data from recording clock generating unit 121 and EFM encoder 125 are each input in recording pulse train generating unit 127, and in recording pulse train generating unit 127, pulse train control signal as shown in FIG. 10 is generated. And, in LD drive unit 130, drive current source 129 of each emission power, Pw, Pb, Pe and Pm corresponding to each pulse, is being switching.

According to the present invention, phase-changing optical recording medium, especially multi-layer phase-changing optical recording medium is able to provide a recording method and an optical recording apparatus capable of forming steadily micro amorphous mark and performing satisfactorily 3 value or more multi-value recording.

Hereafter, the present invention will be further described in details referring to specific examples, however, the present invention is not limited to the disclosed examples. As the usual known recording strategy may be used for the second information layer, the record is omitted.

### EXAMPLE 1

A first substrate consisting of polycarbonate resin having irregularities for tracking guide due to continuous groove on the surface at diameter 12 cm and thickness 0.6 mm is provided.

First of all, on the first substrate, a first lower protective layer consisting of (ZnS)₇₀ (SiO₂)₃₀ is formed to a thickness of 120 nm by sputtering process.

Next, on the first lower protective layer, a first phase-changing recording layer consisting of Sb₇₀Te₂₂Ge₈ is formed to a thickness of 6 nm by sputtering process.

Next, on the first phase-changing recording layer, a first upper protective layer consisting of (ZnS)₇₀ (SiO₂)₃₀ is formed to a thickness of 15 nm by sputtering process.

Next, on the first upper protective layer, a first barrier layer consisting of (TiC)₇₀ (TiO₂)₃₀ is formed to a thickness of 3 nm by sputtering process.

Next, on the first barrier layer, a first reflective layer consisting of Ag is formed to a thickness of 10 nm by sputtering process.

Next, on the first reflective layer, a first thermal diffusion layer consisting of IZO [(In₂O₃)₉₀(ZnO)₁₀] is formed to a thickness of 40 nm by sputtering process.

According to the above, a first information layer is formed on the first substrate.

Sputtering process is performed in Ar gas atmosphere using sheet sputtering apparatus manufactured by Balzers Corporation.

Next, on the second substrate with the same configuration as the first substrate, a second reflective layer consisting of Ag₉₈Pd₁Cu₁ is formed to a thickness of 120 nm by sputtering process.

Next, on the second reflective layer, a second barrier layer consisting of SiC is formed to a thickness of 3 nm by sputtering process.

Next, on the second barrier layer, a second upper protective layer consisting of (ZnS)₇₀ (SiO₂)₃₀ is formed to a thickness of 20 nm by sputtering process.

Next, on the second upper protective layer, a second phase-changing recording layer consisting of composition formula Sb₇₃Te₂₂Ge₅ is formed to a thickness of 14 nm by sputtering process.

Next, on the second phase-changing recording layer, a second lower protective layer consisting of (ZnS)₇₀ (SiO₂)₃₀ is formed to a thickness of 130 nm by sputtering process.

According to the above, a second information layer is formed on the second substrate.

Sputtering process is performed in Ar gas atmosphere using sheet sputtering apparatus manufactured by Balzers Corporation.

Next, laser beam is irradiated to the obtained first information layer and second information layer from the first substrate and the second information layer film surface, respectively, by large diameter LD, and initialization treatment is performed.

Next, an ultraviolet cured resin is coated on the film surface of the first information layer and after sticking together with the second information layer surface of the second substrate and spin-coating, ultraviolet light is irradiated from the first substrate and the ultraviolet cured resin is cured and made an intermediate layer, and a two-layered phase-changing optical recording medium having two information layers is manufactured. The thickness of the intermediate layer is 35 μm.

<Performance Evaluation>

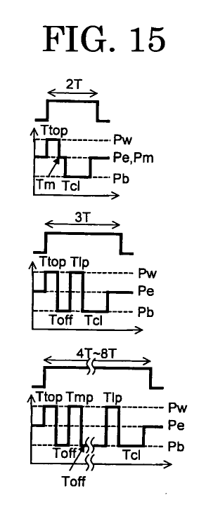

Random pattern of recording bit length 0.16 μm/bit is repeatedly recorded by recording linear speed 6.0 m/sec. with modulation system of (1-7) RLL in the obtained first information layer of the two-layered phase-changing optical recording medium, using a light head of wavelength 407 nm and numerical aperture (NA) 0.65. The recording strategy of each mark at this time is set up as FIG. 15. Of the pulses of the recording strategy, the pulse existing in between a top pulse and a last pulse, where the top pulse is the leading pulse and the last pulse is the final pulse, is defined as multi-value pulse.

The pulse retention period of top pulse, multi-value pulse and last pulse are called Ttop, Tmp and Tlp, respectively, and the off period of top pulse, multi-value pulse and last pulse is called Toff. The cooling time provided after the last pulse is called Tcl and the Pm irradiation time is called Tm. The set value of each power is Pw=14 mW, Pb=0.1 mW, and Pe=Pm=6 mW. Ttop, Tmp and Tlp are all set to 0.2T, Toff to 0.6T and Tcl to 1.0T. Tm is set to 0.2T.

The random signal of each signal of 2T to 8T of repeat recording after 100 times is reproduced with reproduce power Pr=0.8 mW and when the jitter is measured, it is a satisfactorily value of 10% or less.

### EXAMPLE 2

A second substrate consisting of polycarbonate resin having irregularities for tracking guide use by continuous groove on the surface at diameter 12 cm and thickness 1.1 mm is provided.

First of all, on the second substrate with the same configuration as the first substrate, a second reflective layer consisting of Ag₉₈Pd₁Cu₁ is formed to a thickness of 120 nm by sputtering process.

Next, on the second reflective phase, a second barrier layer consisting of TiO₂ is formed to a thickness of 3 nm by sputtering process.

Next, on the second barrier layer, a second upper protective layer consisting of (ZnS)₇₀ (SiO₂)₃₀ is formed to a thickness of 15 nm by sputtering process.

Next, on the second upper protective layer, a second phase-changing recording layer consisting of Ge₅Ag₁In₂Sb₇₀Te₂₂ is formed to a thickness of 12 nm by sputtering process.

Next, on the second phase-changing recording layer, a second lower protective layer consisting of (ZnS)₇₀ (SiO₂)₃₀ is formed to a thickness of 130 nm by sputtering process.

According to the above, a second information layer is formed on the second substrate.

Sputtering process is performed in Ar gas atmosphere using sheet sputtering apparatus manufactured by Balzers Corporation.

A resin is coated on the obtained second information layer and an intermediate layer having irregularities for tracking guide due to continuous groove is formed by 2P (photo polymerization) method. The thickness of the intermediate layer is 30 μm.

Next, on the intermediate layer, a first thermal diffusion layer consisting of ITO [(In₂O₃)₉₀ (SnO₂)₁₀] is formed to a thickness of 120 nm by sputtering process.

Next, on the first thermal diffusion layer, a first reflective layer consisting of Ag is formed to a thickness of 10 nm by sputtering process.

Next, on the first reflective layer, a first barrier layer consisting of TiO₂ is formed to a thickness of 3 nm by sputtering process.

Next, on the first barrier layer, a first upper protective layer consisting of (ZnS)₇₀ (SiO₂)₃₀ is formed to a thickness of 10 nm by sputtering process.

Next, on the first upper protective layer, a first upper interface layer consisting of GeN is formed to a thickness of 2 nm by sputtering process.

Next, on the first upper interface layer, a first phase-changing recording layer consisting of Ge₄Ag₁Sb₆₇Te₂₈ is formed to a thickness of 5 nm by sputtering process.

Next, on the first phase-changing recording layer, a first lower interface layer consisting of GeN is formed to a thickness of 2 nm by sputtering process.

Next, on the first lower interface layer, a first lower protective layer consisting of (ZnS)₇₀ (SiO₂)₃₀ is formed to a thickness of 120 nm by sputtering process.

According to the above, a first information layer is formed Next, on the obtained film surface of the first information layer, a two-layered phase-changing optical recording medium is manufactured by sticking the first substrate consisting of polycarbonate film of diameter 12 cm and thickness 40 μm through a transparent layer consisting of a double-sided adhesive sheet of a thickness of 45 μm.

Different from this, on the second substrate of thickness 1.1 mm, the same first information layer, transparent layer and first substrate as the above-mentioned are provided similarly for the transmittance measurement use and the light transmittance from the first substrate side is measured.

### EXAMPLES 3 TO 10

Except for the thickness of first thermal diffusion layer, first reflective layer, first phase-changing recording layer and second phase-changing recording layer in example 2, which were changed respectively as shown in Tables 1 and 2, a two-layered phase-changing optical recording medium is manufactured in the same way as example 2.

For each optical recording medium of the obtained examples 2 to 10, recording is performed with the following condition.
laser wavelength:407 nm
numerical aperture (NA):0.85
linear speed:5.28 m/s
track pitch:0.32 μm

Tables 1 and 2 show the measurement results of the jitter of 2T mark of the first information layer and second information layer, and the jitter of 2T mark of the first information layer and second information layer after 100 times over light when recording (1-7) RLL signal with linear density 0.12 μm/bit. The recording strategy for the first information layer is set up as FIG. 15.

TABLE 1

| | Thickness | | | |
|---|---|---|---|---|
| | of first | Thickness | Thickness | Thickness |
| | thermal | of first | of first | of second |
| | diffusion | reflective | recording | recording |
| | layer[nm] | layer[nm] | layer[nm] | layer[nm] |
| Example 2 | 120 | 10 | 5 | 12 |
| Example 3 | 10 | 10 | 6 | 10 |
| Example 4 | 40 | 10 | 5 | 18 |
| Example 5 | 80 | 5 | 6 | 6 |
| Example 6 | 100 | 10 | 6 | 10 |
| Example 7 | 120 | 10 | 8 | 15 |
| Example 8 | 140 | 10 | 6 | 8 |
| Example 9 | 35 | 15 | 5 | 5 |
| Example 10 | 35 | 5 | 10 | 13 |

TABLE 2

| | | | Jitter after one recording[%] | | Jitter after 100 recording[%] | |
|---|---|---|---|---|---|---|
| | | | First | Second | First | Second |
| | Light transmittance[%] | | information | information | information | information |
| | Amorphous | Crystal | layer | layer | layer | layer |
| Example 2 | 47 | 50 | 6.4 | 6.9 | 6.6 | 7.2 |
| Example 3 | 47 | 51 | 7.1 | 6.8 | 7.7 | 7.2 |
| Example 4 | 50 | 53 | 6.9 | 7.3 | 7.0 | 7.9 |
| Example 5 | 48 | 50 | 6.5 | 6.6 | 6.8 | 6.9 |
| Example 6 | 47 | 52 | 6.8 | 6.7 | 7.0 | 7.1 |
| Example 7 | 44 | 49 | 6.4 | 6.8 | 6.6 | 7.4 |
| Example 8 | 47 | 53 | 6.8 | 6.6 | 7.0 | 7.2 |
| Example 9 | 45 | 49 | 6.7 | 6.8 | 6.8 | 7.8 |
| Example 10 | 41 | 46 | 6.3 | 7.1 | 6.7 | 7.6 |

From the results of Tables 1 and 2, the optical recording medium, too, of any one of examples 2 to 10 where the light transmittance is 40% or more, and after one recording, the jitter after 100 times over write is 9% or less, and it excels as an optical recording medium.

From the above, the optical recording medium of the present invention is capable of performing recording reproduction satisfactorily by adjusting the thickness of the first substrate in the range of 10 μm to 600 μm even in the case of changed numerical aperture NA of objective lens performing recording reproduction.

From other experiments also, satisfactory recording reproduction in both first information layer and second information layer is possible if the thickness of the recording layer of first information layer is 3 nm to 10 nm, the reflective layer is 3 nm to 20 nm, thermal diffusion layer is 10 nm to 200 nm, and the thickness of the recording layer of second information layer is 3 nm to 20 nm. However, if the recording layer thickness and reflective layer thickness of the first information layer is thicker than 10 nm and 20 nm, respectively, light transmittance after initialization cannot be increased to 40% or more, therefore, satisfactory recording is not possible in the second information layer. If the thermal diffusion layer is thicker than 200 nm, it takes at least 60 seconds to manufacture a two-layered optical disk, and is difficult in mass production.

1. A recording method for optical recording medium comprising:
irradiating repeatedly by a recording power (Pw) light and a cooling power (Pb) light to an information layer comprising a phase-changing recording layer of the optical recording medium,
forming a few types of amorphous mark vary from at least any one from length and area, and
recording information and forming a crystal space upon irradiation of an erasing power (Pe) light,
wherein the recording power (Pw) light, the cooling power (Pb) light, and the erasing power (Pe) light satisfying a relation of the following equation Pw>Pe>Pb, and
wherein the recording power (Pw) light, cooling power (Pb) light, and cooling controlling power (Pm) light satisfying a relation of the following equation Pw>Pm>Pb, when forming at least one type of amorphous mark upon irradiation by a cooling controlling power (Pm) light to in between the recording power (Pw) light and cooling power (Pb) light.

2. The recording method for optical recording medium according to claim 1, wherein the recording method for optical recording medium records 3 value and more multi-value data as information by modulating an area of the amorphous mark inside a recording cell.

3. The recording method for optical recording medium according to claim 1, wherein the erasing power (Pe) and cooling controlling power (Pm) are equal.

4. The recording method for optical recording medium according to claim 1, wherein the recording method for optical recording medium controls at least any one of a length and an area of the amorphous mark by changing an irradiation time of the cooling controlling power (Pm) light.

5. The recording method for optical recording medium according to claim 1, wherein the recording method for optical recording medium fixes an irradiation time of the cooling controlling power (Pm) light shorter in a case where any one of a short length amorphous mark and a small area amorphous mark is formed.

6. The recording method for optical recording medium according to claim 1, wherein phase change of the phase-changing recording layer between crystal state and amorphous state is generated and information is recorded by light irradiation to the phase-changing recording layer.

7. The recording method for optical recording medium according to claim 1, wherein the phase-changing recording layer comprises Sb, and at least one element selected from Ge, Ga, In, Zn, Mn, Sn, Ag, Mg, Ca, Bi, Se and Te.

8. The recording method for optical recording medium according to claim 1, wherein the optical recording medium comprises a substrate, and on the substrate in the order or reverse order of a lower protective layer, a phase changing recording layer, an upper protective layer, a reflective layer and a thermal diffusion layer.

9. The recording method for optical recording medium according to claim 8, wherein the thermal diffusion layer comprises any one of an ITO (indium oxide-stannum oxide) and an IZO (indium oxide-zinc oxide).

10. The recording method for optical recording medium according to claim 8, wherein a thickness of the thermal diffusion layer is 10 nm to 200 nm.

11. The recording method for optical recording medium according to claim 8, wherein the reflective layer comprises at least one element selected from Au, Ag, Cu, W, Al, and Ta.

12. The recording method for optical recording medium according to claim 1, wherein the optical recording medium comprises a first substrate, a first information layer, an intermediate layer, and a second information layer and a second substrate.

13. The recording method for optical recording medium according to claim 12, wherein the first information layer comprises in an order of a first lower protective layer, a first phase-changing recording layer, a first upper protective layer, a first reflective layer, and a first thermal diffusion layer.

14. The recording method for optical recording medium according to claim 12, wherein the second information layer comprises in an order of a second lower protective layer, a second phase-changing recording layer, a second upper protective layer, and a second reflective layer.

15. The recording method for optical recording medium according to claim 13, wherein a thickness of the first reflective layer is 3 nm to 20 nm.

16. The recording method for optical recording medium according to claim 1, further comprising an intermediate layer,
wherein the information layer is provided with 2 layers or more through the intermediate layer, and records information in at least a one layer phase-changing recording layer other than a phase-changing recording layer that is arranged at the most back side of a laser beam irradiating side,
wherein an information layer comprising a phase-changing recording layer uses a multi-layered phase-changing optical recording medium provided with 2 layers or more through an intermediate layer.

17. An optical recording apparatus comprising:
an irradiating unit configured to irradiate repeatedly by a recording power (Pw) light and a cooling power (Pb) light to an information layer comprising a phase-changing recording layer of the optical recording medium,
a forming unit configured to form a few types of amorphous mark vary from at least any one from length and area, and
a recorder configured to record information and forming a crystal space upon irradiation of an erasing power (Pe) light,
wherein the recording power (Pw) light, the cooling power (Pb) light, and the erasing power (Pe) light satisfying a relation of the following equation Pw>Pe>Pb, and
wherein the recording power (Pw) light, cooling power (Pb) light, and cooling controlling power (Pm) light satisfying a relation of the following equation Pw>Pm>Pb, when forming at least one type of amorphous mark upon irradiation by a cooling controlling power (Pm) light to in between the recording power (Pw) light and cooling power (Pb) light.
